(19) United States
(12) Patent Application Publication
(10) Pub. No.: US 2015/0027845 A1
(43) Pub. Date: Jan. 29, 2015

(54) Electromagnetic Clutch

(71) Applicant: SANDEN CORPORATION, Isesaki-shi (JP)

(72) Inventor: Masanori Mogi, Isesaki-shi (JP)

(21) Appl. No.: 14/380,642

(22) PCT Filed: Feb. 19, 2013
(86) PCT No.: PCT/JP2013/054025

§ 371 Date: Aug. 22, 2014

(30) Foreign Application Priority Data
Feb. 23, 2012 (JP) 2012-038052

(51) Int. Cl. F16D 27/06; F16D 13/40

(52) U.S. Cl. CPC F16D 27/06; F16D 13/40
USPC 192/84.91

(57) ABSTRACT

An electromagnetic clutch includes: a rotor 1 including therein an electromagnetic coil 16; and an armature 2 facing the rotor 1 and caused to be attached to the rotor 1 by a magnetic force of the electromagnetic coil 16. By excitation of the electromagnetic coil 16, a magnetic circuit M₁ from the rotor 1 back to the rotor 1 through a first armature plate 21, an intermediate layer 22, a second armature plate 23, the intermediate layer 22, and the first armature plate 21 is formed when the rotor 1 and the armature 2 are not in contact, and a magnetic circuit M₂ from the rotor 1 back to the rotor 1 through the first armature plate 21, a part 13a between adjacent slits 14 of the rotor 1, and the first armature plate 21 is formed when the rotor 1 and the armature 2 are in contact.

### TECHNICAL FIELD

The present invention relates to an electromagnetic clutch used in a compressor and the like, and particularly relates to an electromagnetic clutch in which a force attracting an armature to a rotor caused by excitation of an electromagnetic coil is enhanced by use of a stack structure of armature plates as the armature.

### BACKGROUND ART

A conventional electromagnetic clutch has the following structure to enhance a force causing an armature to be attached to a rotor due to excitation of an electromagnetic coil: a plurality of slits are formed in the armature so that a magnetic circuit formed when the armature is attached to the rotor runs to and from the rotor and the armature a plurality of times (for example, see Patent Document 1).

### REFERENCE DOCUMENT LIST

### Patent Document

Patent Document 1: Japanese Patent Application Laid-open Publication No. H08-284976

### SUMMARY OF THE INVENTION

### Problems to be Solved by the Invention

In the conventional electromagnetic clutch, however, a magnetic circuit formed when the armature is attracted by excitation of the electromagnetic coil (i.e. when the rotor and the armature are still separated before the armature is attached to the rotor) needs to pass between the slits formed in the armature. Since a magnetic circuit with slits has a higher magnetic resistance than a magnetic circuit with no slits, the force attracting the armature to the rotor caused by excitation of the electromagnetic coil decreases.

To solve such a problem, the present invention has an object of providing an electromagnetic clutch in which the force attracting an armature to a rotor caused by excitation of an electromagnetic coil is enhanced.

### Means for Solving the Problems

To achieve the stated object, an electromagnetic clutch according to the present invention is an electromagnetic clutch including: a rotor that includes an electromagnetic coil; and an armature that faces the rotor, and is caused to be attached to the rotor by a magnetic force of the electromagnetic coil, in which the rotor has a plurality of concentric slits on a contact surface with the armature, in which the armature includes: a first armature plate that has one or more concentric slits each facing a contact surface between adjacent slits of the rotor; a second armature plate that is placed on a back side of the first armature plate; and an intermediate layer that is placed between the first armature plate and the second armature plate, and is lower in magnetic permeability than each of the first armature plate and the second armature plate, in which, by excitation of the electromagnetic coil, a magnetic circuit from the rotor back to the rotor through the first armature plate, the intermediate layer, the second armature plate, the intermediate layer, and the first armature plate is formed when the rotor and the armature are not in contact with each other, and a magnetic circuit from the rotor back to the rotor through the first armature plate, a part between the adjacent slits of the rotor, and the first armature plate is formed when the rotor and the armature are in contact with each other.

### Effects of the Invention

In the electromagnetic clutch according to the present invention, the magnetic circuit from the rotor back to the rotor through the first armature plate, the intermediate layer, the second armature plate, the intermediate layer, and the first armature plate is formed. This magnetic circuit does not pass through the slit of the first armature plate higher in magnetic resistance, but passes through the second armature plate lower in magnetic resistance. The whole magnetic path M₁ therefore has a lower magnetic resistance. The electromagnetic clutch according to the present invention thus achieves an enhanced force attracting the armature to the rotor caused by excitation of the electromagnetic coil.

### BRIEF DESCRIPTION OF THE DRAWINGS

FIG. 1 is an exploded perspective view illustrating an electromagnetic clutch according to a first embodiment of the present invention.

FIG. 2 is a center cross-sectional view illustrating the electromagnetic clutch.

FIGS. 3A and 3B are exploded plan views illustrating armature plates in the electromagnetic clutch, in which FIG. 3A illustrates a first armature plate and FIG. 3B illustrates a second armature plate.

FIG. 4 is a plan view illustrating the electromagnetic clutch.

FIGS. 5A and 5B are enlarged partial cross-sectional views illustrating a magnetic circuit portion formed in the electromagnetic clutch, in which FIG. 5A illustrates the magnetic circuit portion when a rotor and an armature are not in contact with each other and FIG. 5B illustrates the magnetic circuit portion when the rotor and the armature are in contact with each other.

FIG. 6 is a cross-sectional view illustrating, similarly to FIG. 2, an electromagnetic clutch according to a second embodiment of the present invention.

FIGS. 7A and 7B are enlarged partial cross-sectional views illustrating a magnetic circuit portion formed in the electromagnetic clutch, in which FIG. 7A illustrates the magnetic circuit portion when a rotor and an armature are not in contact with each other and FIG. 7B illustrates the magnetic circuit portion when the rotor and the armature are in contact with each other.

FIG. 8 is a cross-sectional view illustrating, similarly to FIG. 2, an electromagnetic clutch according to a third embodiment of the present invention.

FIGS. 9A and 9B are enlarged partial cross-sectional views illustrating a magnetic circuit portion formed in the electromagnetic clutch, in which FIG. 9A illustrates the magnetic circuit portion when a rotor and an armature are not in contact with each other and FIG. 9B illustrates the magnetic circuit portion when the rotor and the armature are in contact with each other.

### MODE FOR CARRYING OUT THE INVENTION

Hereinbelow, a first embodiment of the present invention will be described with reference to FIGS. to 5.

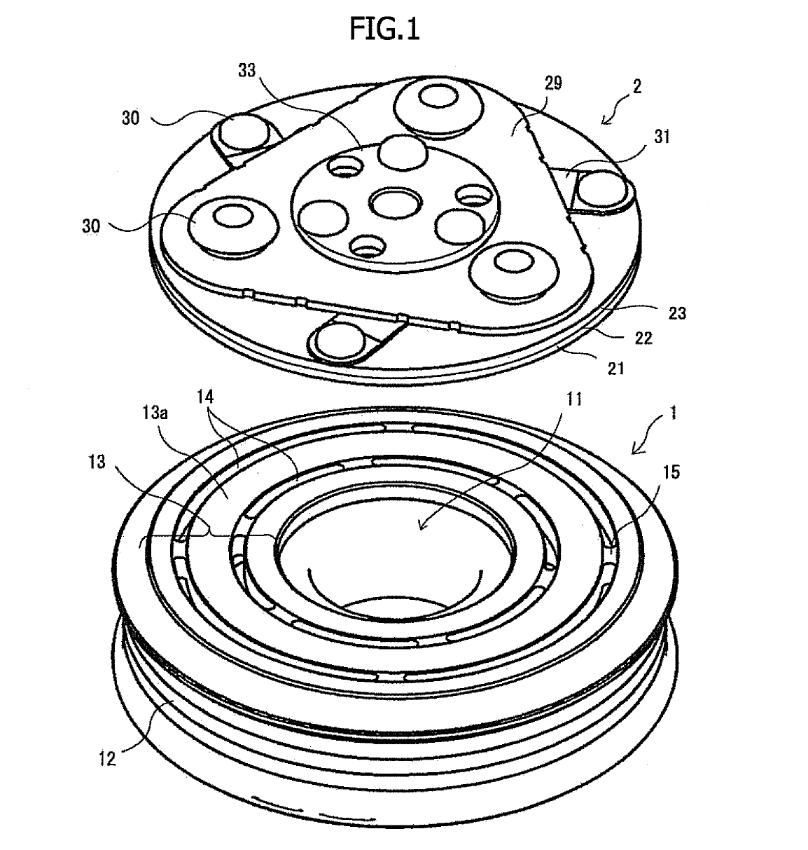

The electromagnetic clutch is a double-flux type electromagnetic clutch used in, for example, a compressor for an automobile or indoor air conditioner, and is provided in a housing of the compressor or the like. As illustrated in FIG. 1, the electromagnetic clutch includes a rotor 1 and an armature 2. The electromagnetic clutch is engaged by contact between the rotor 1 and the armature 2, and transmits power from a power source to drive the compressor.

In double-flux type, the contact surface of each of the rotor 1 and the armature 2 is divided by slits in the radial direction so that the magnetic circuit (hereafter referred to as “magnetic path”) formed when the rotor 1 and the armature 2 are in contact with each other runs to and from the rotor 1 and the armature 2 twice. In triple-flux type, the magnetic path formed when the rotor 1 and the armature 2 are in contact with each other runs to and from the rotor 1 and the armature 2 three times.

The rotor 1 is shaped like a ring with an opening at the center thereof, and is integrally formed with a pulley 12 for transmitting power from a power source (not illustrated) such as an engine. Into the opening 11 formed at the center, a drive shaft (not illustrated) connected to the armature 2 is inserted. The drive shaft is supported by a radial bearing or the like between the drive shaft and a wall surface of the opening 11. The pulley 12 constitutes an outer peripheral portion of the rotor 1. The pulley 12 is connected to the power source by a belt, and rotates the rotor 1.

Slits 14 are formed on a surface (hereafter referred to as “contact surface”) 13 of the rotor 1 that comes into contact with the armature 2. Two slits 14 are concentrically formed on the contact surface 13, thereby dividing the contact surface 13 into three in the radial direction. The three parts of the contact surface 13 divided by the slits 14 are connected by connecting portions 15 formed concentrically with the slits 14.

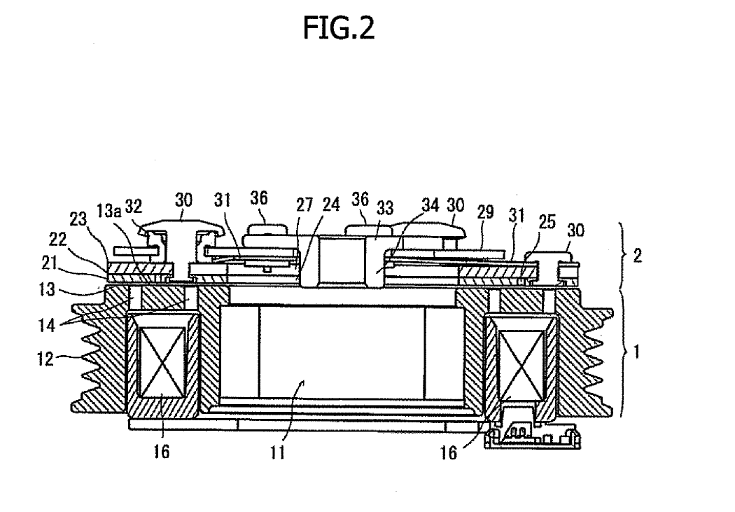

In the rotor 1, electromagnetic coils 16 are provided, as illustrated in FIG. 2. A plurality of electromagnetic coils 16 are arranged on the same circumference, and are each excited by energization to generate a magnetic flux. The generated magnetic flux forms a magnetic path, the total magnetic resistance of which is lowest. The magnetic resistance is expressed by a ratio of the magnetomotive force to the magnetic flux (magnetomotive force/magnetic flux) in a magnetic path. When the electromagnetic coils 16 are excited, their magnetic force causes the armature 2 to be attracted and attached to the rotor 1.

The armature 2 faces the rotor 1, and includes a first armature plate 21, an intermediate layer 22, and a second armature plate 23. The armature 2 is formed by stacking the first armature plate 21, the intermediate layer 22, and the second armature plate 23 in this order from the rotor 1 side. Each of the armature plates 21 and 23 is made of a magnetic material such as iron or an iron oxide. When the electromagnetic coils 16 provided in the rotor 1 are excited, the magnetic force caused thereby causes the attraction and attachment of the armature plates 21 and 23 to the rotor 1.

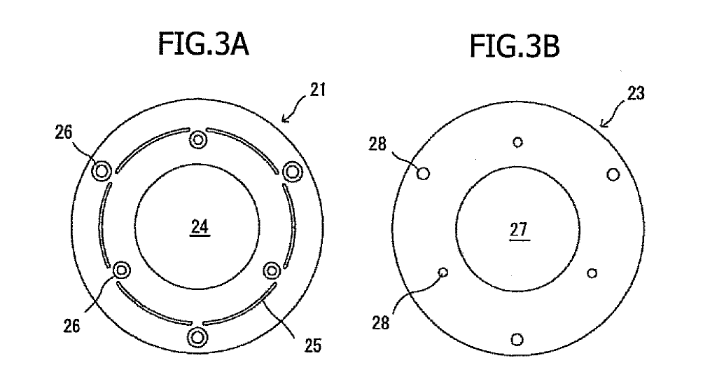

The first armature plate 21 faces the rotor 1. The first armature plate 21 is shaped like a disk having a circular opening 24 at its center, as illustrated in FIG. 3A. The first armature plate 21 has one slit 25 and a plurality of rivet holes 26. The slit 25 has a substantially circular shape with the same center axis as the two slits 14 formed in the rotor 1. The slit 25 is positioned to face a contact surface 13a which is the part of the contact surface 13 of the rotor 1 between the two slits 14 of the rotor 1, as illustrated in FIG. 2. In other words, the two slits 14 of the rotor 1 and the slit 25 of the first armature plate 21 are concentrically formed with different radii, and the radius of the slit 25 of the first armature plate 21 is greater than the radius of the smaller slit 14 of the two slits 14 of the rotor 1 and less than the radius of the larger slit 14.

The second armature plate 23 is placed on the side opposite from rotor 1 across the first armature plate 21 (hereafter referred to as “back side”). The second armature plate 23 is shaped like a disk having a circular opening 27 at its center and a plurality of rivet holes 28, as illustrated in FIG. 3B. The opening 27 of the second armature plate 23 and the opening 24 of the first armature plate 21 are circles having the same center axis and substantially the same radius.

The intermediate layer 22 is placed between the first armature plate 21 and the second armature plate 23. The intermediate layer 22 is a coating film of an anticorrosive or the like applied to a surface of each of the armature plates 21 and 23. A material lower in magnetic permeability than each of the armature plates 21 and 23 is selected as the coating film. The magnetic resistance of the intermediate layer 22 is therefore higher than the magnetic resistance of each of the armature plates 21 and 23. Meanwhile, the magnetic resistance of the intermediate layer 22 is lower than the magnetic resistance of the slit 25 (i.e. the space in the slit 25) of the first armature plate 21. The magnetic resistance of the intermediate layer 22 is set by changing the material or thickness of the coating film.

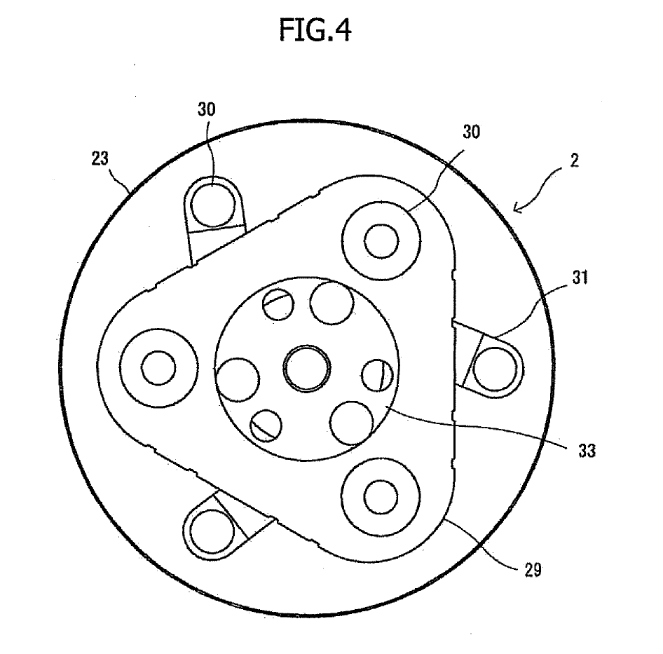

A damping plate 29 is placed on the back side of the second armature plate 23, as illustrated in FIG. 2. The damping plate 29 is a substantially triangular metal member having an opening at its center as illustrated in FIG. 4, and damps the vibrations of the armature 2. The damping plate 29 is connected to the first armature plate 21, the intermediate layer 22, and the second armature plate 23, by rivets 30 inserted through rivet holes 26 of the first armature plate 21 and rivet holes 28 of the second armature plate 23.

Between the second armature plate 23 and the damping plate 29, leaf springs 31 are placed. The leaf springs 31 are biasing means for biasing the armature 2 toward the damping plate 29 (that is, biasing the armature 2 away from the rotor 1). In a case in which the electromagnetic coils 16 of the rotor 1 are not excited, the armature 2 is separated from the rotor 1 by the biasing force of the leaf springs 31. This means the attraction and attachment of the armature 2 by the electromagnetic coils 16 are carried out against the biasing force of the leaf springs 31. Between the second armature plate 23 and the damping plate 29, spacers 32 are placed to keep the space for accommodating the leaf springs 31.

The outer ends of the leaf springs 31 are connected to the first armature plate 21, the intermediate layer 22, and the second armature plate 23, by rivets 30 (see FIG. 2) inserted through the rivet holes 26 of the first armature plate 21 and the rivet holes 28 of the second armature plate 23 illustrated in FIG. 3.

On the back side of the damping plate 29, a coupler 33 is placed, as illustrated in FIG. 2. The coupler 33 is a disk-shaped metal member, a center portion of which protrudes toward the rotor 1 as a sleeve 34, and connects the armature 2 and the drive shaft of the compressor. The sleeve 34 formed at the center portion of the coupler 33 protrudes toward the rotor 1 through the opening 27 of the second armature plate 23 and the opening 24 of the first armature plate 21, and the drive shaft of the compressor is connected to the inside of the sleeve 34. The coupler 33, the damping plate 29, and the inner ends of the leaf springs 31 are connected by bolts 36.

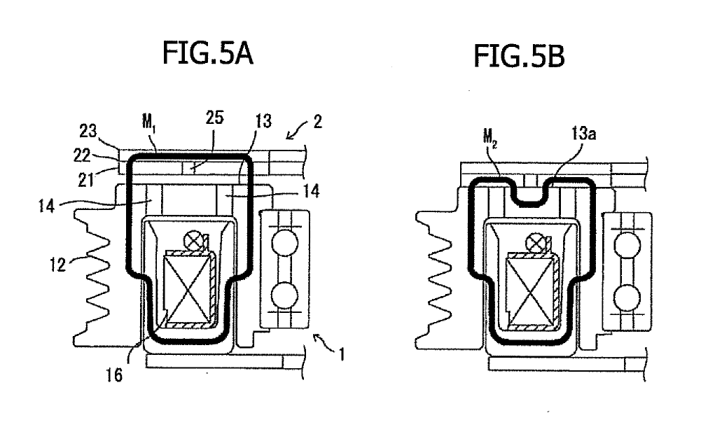

The following describes the magnetic path formed by the electromagnetic clutch having the above-mentioned structure, with reference to FIG. 5.

When the electromagnetic clutch of this embodiment is in a state in which the electromagnetic coils 16 are not excited, the rotor 1 and the armature 2 are separated by the biasing force of the leaf springs 31, and the rotor 1 and the armature 2 are not in contact with each other. If each of the electromagnetic coils 16 is excited by energization when the rotor 1 and the armature 2 are not in contact with each other (hereafter simply referred to as “during non-contact”), a magnetic path M₁ is formed.

The magnetic path M₁ is a closed circuit from the rotor 1 back to the rotor 1 through the first armature plate 21, the intermediate layer 22, the second armature plate 23, the intermediate layer 22, and the first armature plate 21, as illustrated in FIG. 5A. The magnetic permeability of the intermediate layer 22 is lower than the magnetic permeability of each of the armature plates 21 and 23, but the magnetic resistance of the intermediate layer 22 is lower than the magnetic resistance of the slit 25 (i.e. the space in the slit 25) of the first armature plate 21. Accordingly, the magnetic resistance of the magnetic path M₁ is lowest during non-contact.

When the magnetic path M₁ is formed, the armature 2 is attracted to the rotor 1 by the magnetic force. As a result, the rotor 1 and the armature 2 come into contact with each other, and the armature 2 is attached to the rotor 1. When the rotor 1 and the armature 2 are in contact with each other (hereafter simply referred to as “during contact”), a magnetic path M₂ is formed.

The magnetic path M₂ is a closed circuit from the rotor 1 back to the rotor 1 through the first armature plate 21, the contact surface 13a between the two slits 14 of the rotor 1, and the first armature plate 21, as illustrated in FIG. 5B. Lines of magnetic force which have entered the first armature plate 21 from the rotor 1 do not pass through the intermediate layer 22 lower in magnetic permeability than the first armature plate 21, but enter the rotor 1 higher in magnetic permeability than the intermediate layer 22 from the contact surface 13a between the two slits 14 of the rotor 1. Having entered the rotor 1, the lines of magnetic force bypass the slit 25 of the first armature plate 21, and enter the first armature plate 21 again. Having entered the first armature plate 21 again, the lines of magnetic force enter the rotor 1 again from the contact surface 13 between the rotor 1 and the armature 2. The magnetic path M₂ is formed in this way. Thus, the magnetic path M₂ runs to and from the rotor 1 and the first armature plate 21 twice, while bypassing the slits 14 of the rotor 1 and the slit 25 of the first armature plate 21.

The electromagnetic clutch according to this embodiment includes: the rotor 1 that includes therein the electromagnetic coil 16; and the armature 2 that faces the rotor 1, and is attracted and attached to the rotor 1 by the magnetic force of the electromagnetic coil 16. The rotor 1 has the two concentric slits 14 on the contact surface 13 with the armature 2. The armature 2 includes: the first armature plate 21 that has the one concentric slit 25 facing the contact surface 13a between the adjacent slits 14 of the rotor 1; the second armature plate 23 that is placed on the back side of the first armature plate 21; and the intermediate layer 22 that is placed between the first armature plate 21 and the second armature plate 23, and is lower in magnetic permeability than each of the armature plates 21 and 23. In the electromagnetic clutch, by excitation of the electromagnetic coil 16, the magnetic path M₁ from the rotor 1 back to the rotor 1 through the first armature plate 21, the intermediate layer 22, the second armature plate 23, the intermediate layer 22, and the first armature plate 21 is formed when the rotor 1 and the armature 2 are not in contact with each other, and the magnetic path M₂ from the rotor 1 back to the rotor 1 through the first armature plate 21, the contact surface 13a between the adjacent slits 14 of the rotor 1, and the first armature plate 21 is formed when the rotor 1 and the armature 2 are in contact with each other.

In such a structure, the magnetic path M₁ formed during non-contact does not pass through the slit 25 of the first armature plate 21 higher in magnetic resistance, but passes through the second armature plate 23 lower in magnetic resistance. The whole magnetic path M₁ therefore has a lower magnetic resistance. The force attracting the armature 2 to the rotor 1 caused by excitation of the electromagnetic coil 16 can be enhanced in this way.

Moreover; the magnetic path M₂ formed during contact runs to and from the rotor 1 and the first armature plate 21 twice. The force causing the armature 2 to be attached to the rotor 1 due to excitation of the electromagnetic coil 16 can be enhanced in this way.

Furthermore, according to this embodiment, the intermediate layer 22 is a coating film, and so can be formed easily. Since an anticorrosive or the like applied to the surface of the armature can be used as the coating film, there is no need for a new material.

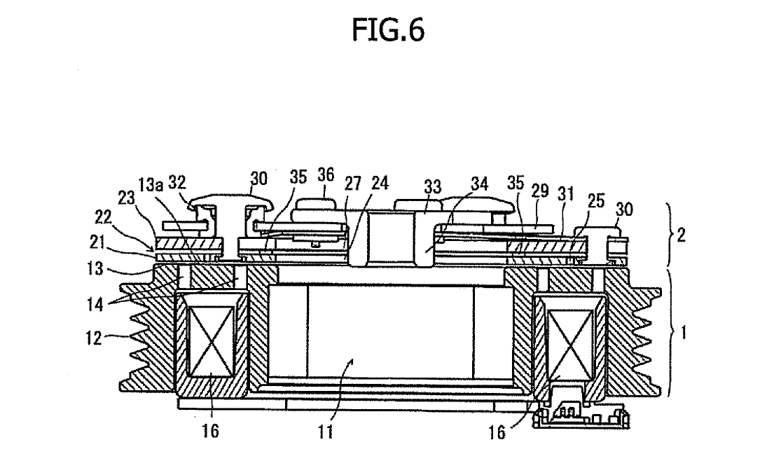

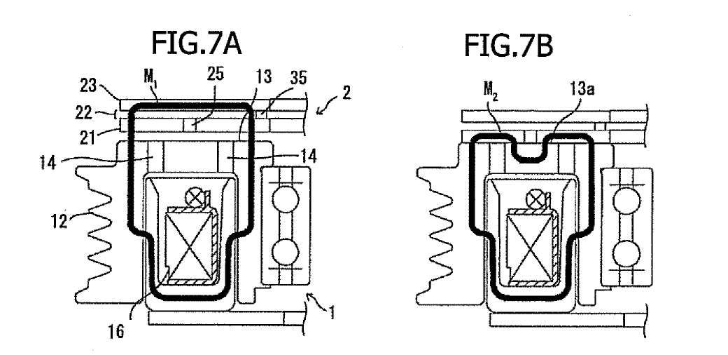

Next, a second embodiment of the present invention will be described with reference to FIGS. 6 and 7. The differences from the first embodiment are described below.

In this embodiment, the second armature plate 23 is placed on the back side of . the first armature plate 21, and a spacer 35 is disposed between the armature plates 21 and 23 to keep a predetermined air layer (space) between the armature plates 21 and 23, as illustrated in FIG. 6. The air layer functions as the intermediate layer 22 in this embodiment.

The magnetic permeability of the intermediate layer 22 in this embodiment is equal to the magnetic permeability of air, and so is lower than the magnetic permeability of each of the armature plates 21 and 23. The magnetic resistance of the intermediate layer 22 is accordingly higher than the magnetic resistance of each of the armature plates 21 and 23. Meanwhile, the magnetic resistance of the intermediate layer 22 is set to be lower than the magnetic resistance of the slit 25 (i.e. the space in the slit 25) of the first armature plate 21. The magnetic resistance of the intermediate layer 22 is set by changing the width of the intermediate layer (air layer) 22. In particular, it is preferable that the width of the intermediate layer 22 is less than the width of the slit 25.

In the electromagnetic clutch in this embodiment, the magnetic circuit M₁ during non-contact is a closed circuit from the rotor 1 back to the rotor 1 through the first armature plate 21, the intermediate layer 22, the second armature plate 23, the intermediate layer 22, and the first armature plate 21, as illustrated in FIG. 7A. The magnetic circuit M₂ during contact is a closed circuit from the rotor 1 back to the rotor through the first armature plate 21, the contact surface 13a between the two slits 14 of the rotor 1, and the first armature plate 21, as illustrated in FIG. 7B.

According to this embodiment, the intermediate layer 22 is an air layer formed between the armature plates 21 and 23, and so can be formed easily. In addition, the magnetic resistance of the intermediate layer 22 can be easily adjusted by changing the height of the spacer 35.

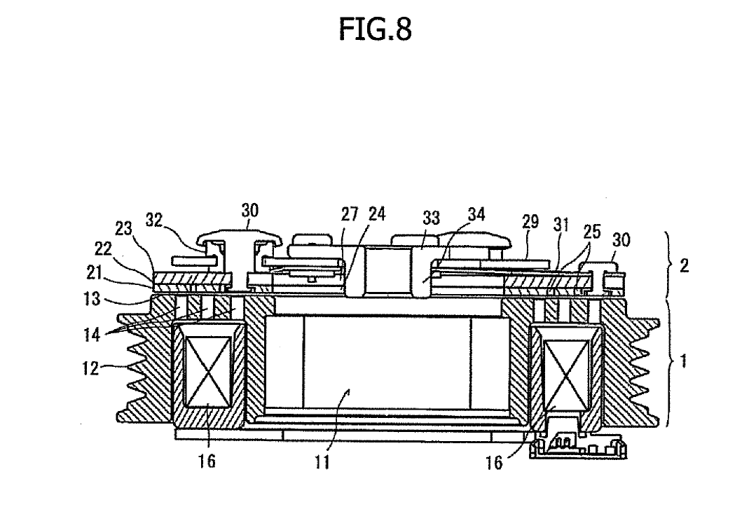

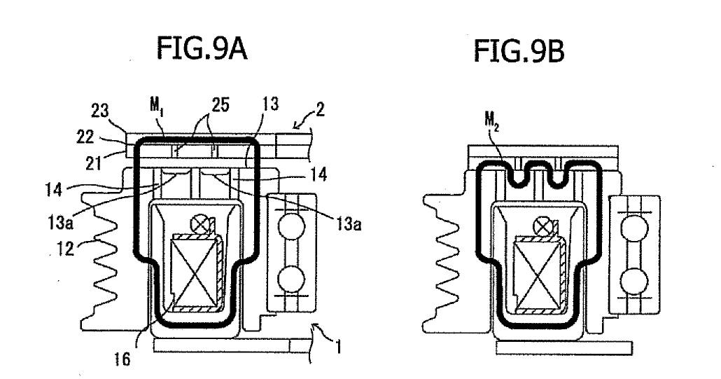

Next, a third embodiment of the present invention will be described with reference to FIGS. 8 and 9. The differences from the foregoing embodiments are described below.

The electromagnetic clutch in this embodiment is triple-flux type electromagnetic clutch, as illustrated in FIG. 8. In detail, the rotor 1 has three concentric slits 14 on the contact surface 13 with the armature 2, and the first armature plate 21 has two concentric slits 25 facing respective two contact surfaces 13a (see FIG. 9A) each of which is defined by adjacent two slits 14 of the three slits 14.

In the electromagnetic clutch in this embodiment, the magnetic circuit M₁ during non-contact is a closed circuit from the rotor 1 back to the rotor 1 through the first armature plate 21, the intermediate layer 22, the second armature plate 23, the intermediate layer 22, and the first armature plate 21, as illustrated in FIG. 9A. The magnetic circuit M₂ during contact is a closed circuit from the rotor 1 back to the rotor 1 through the first armature plate 21, one contact surface 13a between adjacent slits 14 of the rotor 1, the first armature plate 21, the other contact surface 13a between adjacent slits 14 of the rotor 1, and the first armature plate 21, as illustrated in FIG. 9B. Thus, the magnetic path M₂ during contact runs to and from the rotor 1 and the armature 2 three times. This structure enhances the force causing of the armature 2 to be attached to the rotor 1 due to excitation of the electromagnetic coil 16.

Although the embodiments of the present invention have been described above, the present invention is not limited thereto. Each of the first armature plate 21, the intermediate layer 22, and the second armature plate 23 may be a stack structure of a plurality of plate-like members. For example, the second armature plate 23 may be formed by stacking two or more second armature plates 23 described in the embodiments.

Although the rotor 1 is formed integrally with the pulley 12, but it is not limited thereto. For example, the rotor 1 and the pulley 12 prepared separately may be joined by welding or the like.

The electromagnetic clutch is not limited to double-flux type or triple-flux type electromagnetic clutch, and the magnetic path M₂ during contact may runs to and from the rotor 1 and the armature 2 four or more times. For example, in a case in which the magnetic path M₂ during contact runs to and from the rotor 1 and the armature 2 N times, the rotor 1 has N concentric slits 14 on the contact surface 13 with the armature 2, and the armature 2 has (N−1) concentric slits 25 facing respective (N−1) contact surfaces 13a each of which is between adjacent slits 14 of the rotor 1. This structure enhances the force causing the armature 2 to be attached to the rotor 1 due to excitation of the electromagnetic coil 16.

The intermediate layer 22 may be made of a material, such as soft iron or nickel, lower in magnetic permeability than each of the armature plates 21 and 23. In such a case, the magnetic resistance of the intermediate layer 22 is set to be lower than the magnetic resistance of the slit 25 (i.e. the space in the slit 25) of the first armature plate 21. The magnetic resistance of the intermediate layer 22 can be adjusted by changing the thickness or material of the intermediate layer.

### REFERENCE SYMBOL LIST

1 Rotor
11, 24, 27 Opening
12 Pulley
13, 13a Contact surface
14 Slit
15 Connecting portion
16 Electromagnetic coil
2 Armature
21 First armature plate
22 Intermediate layer
23 Second armature plate
25 Slit
26, 28 Rivet hole
29 Damping plate
30 Rivet
31 Leaf spring
32, 35 Spacer
33 Coupler
34 Sleeve
36 Bolt
M₁, M₂ Magnetic circuit (magnetic path)

1. An electromagnetic clutch comprising:
a rotor that includes therein an electromagnetic coil; and
an armature that faces the rotor, and is caused to be attached to the rotor by a magnetic force of the electromagnetic coil,
wherein the rotor has a plurality of concentric slits on a contact surface with the armature,
wherein the armature includes: a first armature plate that has one or more concentric slits each facing a contact surface between adjacent slits of the rotor; a second armature plate that is placed on a back side of the first armature plate; and an intermediate layer that is placed between the first armature plate and the second armature plate, and is lower in magnetic permeability than each of the first armature plate and the second armature plate, and
wherein, by excitation of the electromagnetic coil, a magnetic circuit from the rotor back to the rotor through the first armature plate, the intermediate layer, the second armature plate, the intermediate layer, and the first armature plate is formed when the rotor and the armature are not in contact with each other, and a magnetic circuit from the rotor back to the rotor through the first armature plate, a part between the adjacent slits of the rotor, and the first armature plate is formed when the rotor and the armature are in contact with each other.

2. The electromagnetic clutch according to claim 1, wherein the intermediate layer is a coating film.

3. The electromagnetic clutch according to claim 1, wherein the intermediate layer is an air layer formed between the first armature plate and the second armature plate.
